(19) United States
(12) Patent Application Publication
(10) Pub. No.: US 2008/0012928 A1
(43) Pub. Date: Jan. 17, 2008

(54) Producing standard format and wide-format prints with efficient donor material use

(75) Inventor: Steven J. Sparer, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/486,203

(22) Filed: Jul. 13, 2006

(51) Int. Cl. B41J 2/00

(52) U.S. Cl. 347/188

(57) ABSTRACT

Standard format images having a length L in a print direction and wide-format images having a length greater than 2L in the print direction can be selectively printed from the same set of donor patches. At least one print order is received at a thermal printer requesting the printing of an image of one of the standard format and the wide-format. A donor ribbon having patches of donor material of length in the print direction greater than 2L is advanced through the thermal printer in the print direction said donor ribbon. An image based upon each print order is printed such that the printing is performed using donor material on (1) a fraction of a donor patch when the print order requests a standard format image, and (2) up to a full donor patch when the print order requests a wide-format image.

### CROSS REFERENCE TO RELATED APPLICATIONS

Reference is made to commonly assigned, co-pending patent applications U.S. Ser. No. 11/060,177, entitled SYSTEM AND METHOD FOR EFFICIENT DONOR MATERIAL USE, filed Feb. 17, 2005 in the names of Robert F. Mindler et al.; U.S. Ser. No. 11/060,178, entitled SYSTEM AND METHOD FOR EFFICIENT DONOR MATERIAL USE, filed Feb. 17, 2005 in the name of Robert F. Mindler; and U.S. Ser. No. 11/192,346, entitled SYSTEM AND METHOD FOR EFFICIENT DONOR MATERIAL USE, filed Jul. 28, 2005 in the names of Anderson et al.

### FIELD OF THE INVENTION

The present invention relates to thermal printers that record images by transferring donor materials from a donor ribbon onto a receiver medium and methods for operating the same to provide a greater range of printing options.

### BACKGROUND OF THE INVENTION

In thermal printing, as that phrase is used herein, it is generally well known to render images by selectively heating and pressing one or more donor materials such as a dye, colorant or coating against a receiver medium. The donor materials are provided in sized donor patches on a movable web known as a donor ribbon. The donor patches are organized on the donor ribbon in donor patch sets. Each donor patch set contains all of the donor patches that are to be used to record an image on the receiver medium. For full color images, a donor patch set can use multiple patches of differently colored donor material, such as yellow, magenta and cyan donor dye patches. Arrangements of other color patches can be used in like fashion within a donor patch set. Additionally, each donor patch set can include an overcoat or sealant layer.

It will be appreciated from this that the size of the donor patches defines the full size of an image that can be printed using a conventional thermal printer. To provide flexibility of use, many thermal printers are capable of printing relatively large images such as 6″×8″ images. While prints of this size are highly desirable for many uses, it can be challenging to use and store images printed at this size. Accordingly, consumers often request that such printers render images at a fraction of the full size image, such as images printed at the wallet size, 3″×5″ size or 4″×6″ size. Images at these sizes are more easily used and stored while exhausting only a fraction of the donor material from a donor patch set leaving a fraction donor patch set. Accordingly, many printers are set up to produce only these smaller, more popular standard size prints such as 4″×6″ prints.

Recent developments in digital capture devices (i.e., digital cameras) and image processing software applications provide a way to easily create wide aspect ratio images some commonly known as panorama format images from multiple images. Many digital cameras allow the photographer set the camera into a “Panorama” mode, which automatically stitches multiple (single) images into one file after the last image in the sequence has been captured. Examples of such a feature can be found in a Canon SD450 or Kodak V570 digital camera.

Although attractive to view these images on a computer monitor the photographer would not be able to print wide-format images of, say, 6″×12″ on a dye sublimation thermal printer that has been set up to produce only 4″×6″ images since these print engines are not capable in printing images larger than the largest dye frame in the series of dye frames. Thus, a photographer would need to send the wide-format image file to a specialized printing system to obtain hard copy prints. Continuous printing Thermal Printers (Kodak ML500) employing digital front ends are capable in printing wide-format. However, these printers are expensive to own or lease and tend to be “specialized” equipment targeted towards the professional vs. consumer markets.

What is needed in the art is a thermal printer having the ability to print wide-format images, but to also have the ability to efficiently print standard, non-wide-format images using the same set of donor patches without waste.

### BRIEF DESCRIPTION OF THE DRAWINGS

FIG. 1 shows a printer driver and printer according to the present invention;

FIG. 2 shows a donor ribbon according to the present invention;

FIG. 3 shows a printhead, donor ribbon and receiver ribbon at a start of a first printing process for a first donor patch;

FIG. 4 shows a printhead, donor ribbon and receiver ribbon at a conclusion of a first printing process for a first donor patch;

FIG. 5 shows a donor ribbon with two sets of donor patches dimensioned conventionally to produce standard sized prints;

FIG. 6 shows a donor ribbon with a set of donor patches dimensioned useful in generating a wide-format image;

FIG. 7 shows a flow diagram of a method for operating a printer in accordance with the present invention;

FIG. 8 illustrates a thermal printing system and donor ribbon at the start of a first printing operation;

FIG. 9 illustrates the donor ribbon of FIG. 8 after the first printing operation;

FIG. 10 illustrates the donor ribbon of FIG. 8 at the start of a second printing operation;

FIG. 11 illustrates the donor ribbon of FIG. 8 after the second printing operation; and

FIG. 12 shows a donor ribbon with a set of donor patches dimensioned in accordance with one embodiment, and a set of standard size images and a wide-format sized image printed using donor ribbon.

### SUMMARY OF THE INVENTION

According to a feature of the present invention, standard format images having a length L in a print direction and wide-format images having a length greater than 2L in the print direction can be selectively printed from the same set of donor patches. At least one print order is received at a thermal printer requesting the printing of an image of one of the standard format and wide format. A donor ribbon having patches of donor material of length greater than 2L in the print direction is advanced through the thermal printer in the print direction. An image based upon each print order is printed such that the printing is performed using donor material on (1) a fraction of a donor patch when the print order requests a standard format image, and (2) up to a full donor patch when the print order requests a wide-format image.

### DETAILED DESCRIPTION OF THE INVENTION

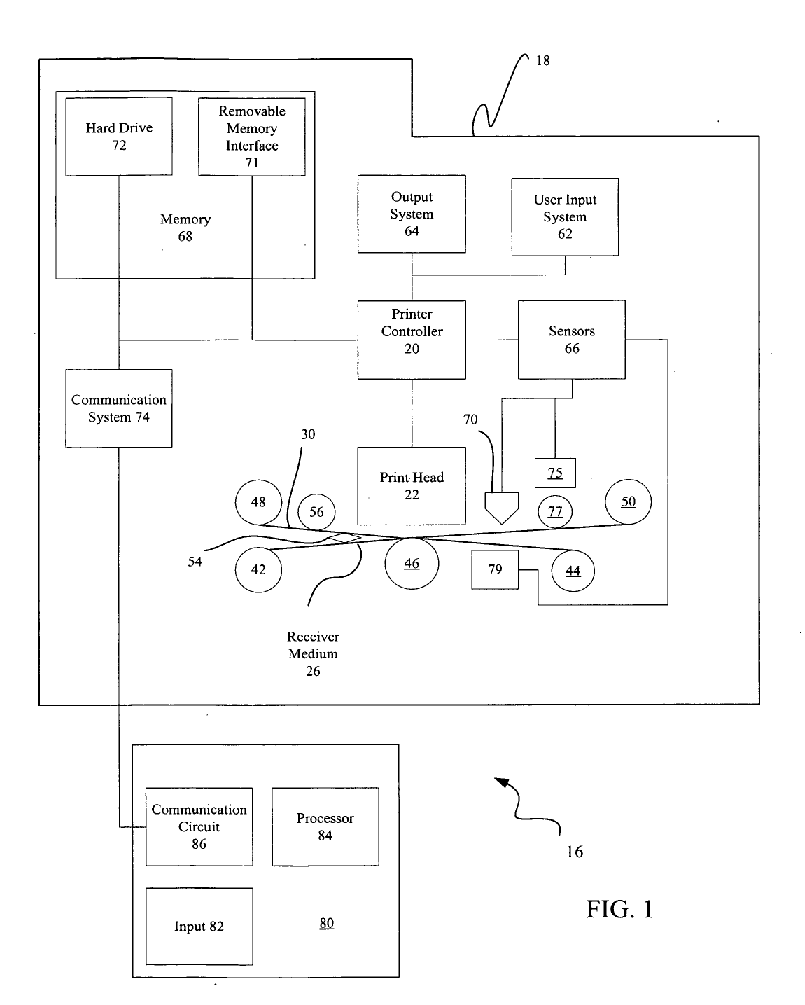

FIGS. 1-4 show a first embodiment of a printing system 16. As is shown in FIG. 1, printing system 16 comprises: a printer 18 and a separate printer driving device 80. Printer 18 includes a controller 20 adapted to cause a printhead 22 to record images on a receiver medium 26 by transferring material from a donor ribbon 30 to receiver medium 26. Controller 20 can include but is not limited to a programmable digital computer, a programmable microprocessor, a programmable logic controller, a series of electronic circuits or a series of electronic circuits reduced to the form of an integrated circuit, or a series of discrete components. Controller 20 also controls a receiver medium take-up roller 42, a receiver medium supply roller 44, a donor ribbon take-up roller 48 and a donor ribbon supply roller 50, which are motorized for rotation on command of the controller 20 to effect movement of receiver medium 26 and donor ribbon 30.

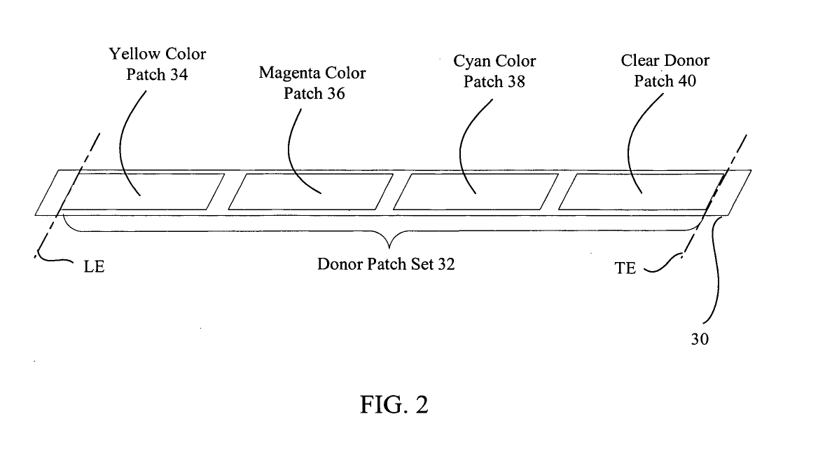

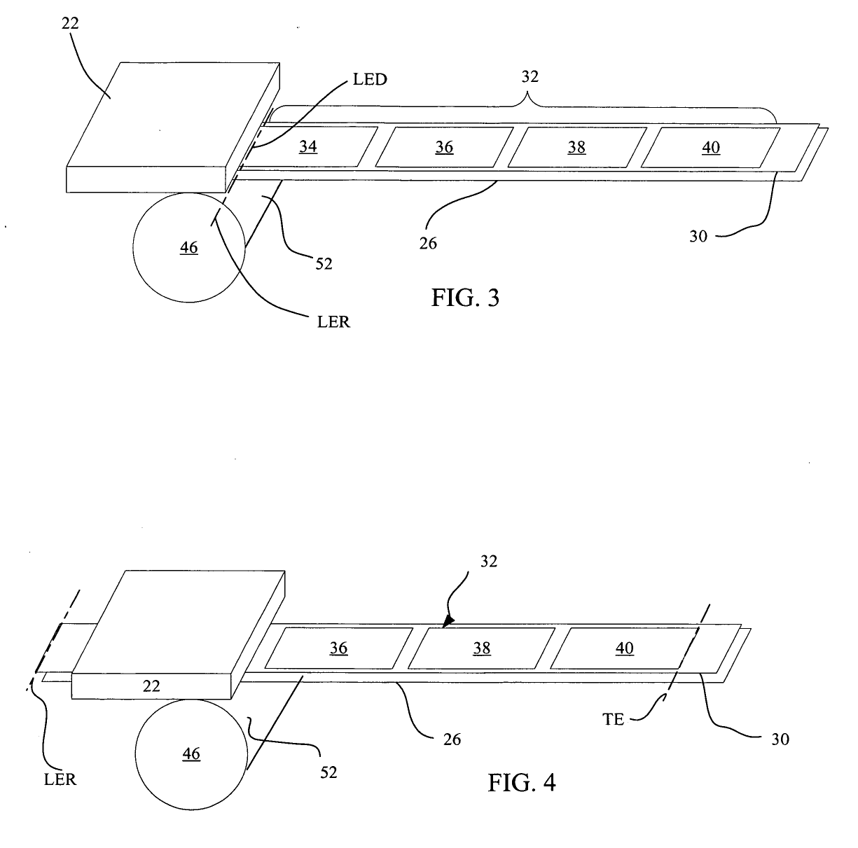

As is shown in FIG. 2, donor ribbon 30 comprises a first donor patch set 32 having a yellow donor patch 34, a magenta donor patch 36, a cyan donor patch 38 and a clear overcoat patch 40. Second and subsequent sets of donor patches follow. Each set of donor patches has a leading edge (LE) and a trailing edge (TE). In order to provide a full color image with a clear protective coating, the four patches of each set of donor patches are printed, in registration with each other, onto a common image receiving area 52 of receiver medium 26 shown in FIG. 3.

A first color is printed by moving donor ribbon 30 in the conventional direction, from right to left with respect to printhead 22 as seen in FIGS. 1 and 3. During printing, controller 20 raises printhead 22 and actuates donor ribbon supply roller 50 and donor ribbon take-up roller 48 to advance a leading edge LE of first donor patch set 32 to printhead 22. Leading edge LE of first donor patch set 32 is defined by at a leading edge of yellow donor patch 34. The position of this leading edge LE can be determined by using a donor position sensor 70 to detect a marking, indicia on donor ribbon 30 that has a known position relative to the leading edge of yellow donor patch 34 or by directly detecting leading edge of yellow donor patch 34 as will be discussed in greater detail below.

Controller 20 also actuates receiver medium take-up roller 42 and receiver medium supply roller 44 so that image receiving area 52 of receiver medium 26 is positioned with respect to printhead 22. An image receiving area 52 is defined by a leading edge LER and a trailing edge TER on receiver medium 26. When donor ribbon 30 and receiver medium 26 are positioned so that a leading edge LED of yellow donor patch 34 is registered at printhead 22 with leading edge LER of image receiving area 52. Controller 20 then lowers printhead 22 so that a lower surface of donor ribbon 30 engages receiver medium 26, which is supported by platen roller 46.

Controller 20 then actuates receiver medium take-up roller 42, receiver medium supply roller 44, donor ribbon take-up roller 48 and donor ribbon supply roller 50 to move receiver medium 26 and donor ribbon 30 together past printhead 22. Controller 20 selectively operates heater elements (not shown) in printhead 22 to transfer donor material from yellow donor patch 34 to receiver medium 26. As donor ribbon 30 and receiver medium 26 leave the printhead 22, a stripping plate 54 separates donor ribbon 30 from receiver medium 26. Donor ribbon 30 continues over idler roller 56 toward the donor ribbon take-up roller 48. As shown in FIG. 4, after printing the trailing edge TER of image receiving area 52 of receiver medium 26 remains on platen roller 46. Controller 20 then adjusts the position of donor ribbon 30 and receiver medium 26 using a predefined pattern of donor ribbon movement so that a leading edge of each of the remaining donor patches 36, 38 and 40 are brought into alignment with leading edge LER of image receiving area 52 and the printing process is repeated to transfer further material as desired to complete image format.

Controller 20 operates the printer 18 based upon input signals from a user input system 62, sensors 66, a memory 68 and a communication system 74.

User input system 62 can comprise any form of transducer or other device capable of receiving an input from a user and converting this input into a form that can be used by controller 20. For example, user input system 62 can comprise a touch screen input, a touch pad input, a 4-way switch, a 6-way switch, an 8-way switch, a stylus system, a trackball system, a joystick system, a voice recognition system, a gesture recognition system or other such systems. An output system 64, such as a display, is optionally provided and can be used by controller 20 to provide human perceptible signals for feedback, informational or other purposes.

Sensors 66 can include light sensors and other sensors known in the art that can be used to detect conditions in the environment-surrounding printer 18 and to convert this information into a form that can be used by controller 20 in governing printing operation. Referring to FIG. 1, sensors 66 include a donor position sensor 70 that is adapted to detect the position of donor ribbon 30 and a receiver medium position sensor 79. Controller 20 cooperates with donor position sensor 70 to monitor donor ribbon 30 during movement thereof so that controller 20 can detect one or more conditions on donor ribbon 30 that indicate a leading edge LE of a donor patch set. In this regard, donor ribbon 30 can be provided that has markings or other optically, magnetically or electronically sensible indicia between each donor patch set. Where such markings or indicia are provided, donor position sensor 70 senses these markings or indicia and provides signals to controller 20. Controller 20 can use these markings and indicia to determine when donor ribbon 30 is positioned with the leading edge LE of a donor patch set or when any of the edges of any of the donor patches is at printhead 22. In a similar way, controller 20 can use signals from receiver medium position sensor 79 to monitor the position of receiver medium 26 to align receiver medium 26 during printing.

During a full image printing operation, controller 20 causes donor ribbon 30 to be advanced in a predetermined pattern of distances so as to cause a leading edge of each of the donor patches 34, 36, 38 and 40, of first donor patch set 32, to be properly positioned relative to the image receiving area 52 at the start of each printing process. Controller 20 can be adapted to achieve such positioning by precise control of the movement of donor ribbon 30 using a stepper type motor for motorizing donor ribbon take-up roller 48 or donor ribbon supply roller 50 or by using a movement sensor 75 that can detect movement of donor ribbon 30. In one example an arrangement using a movement sensor 75, a follower wheel 77 is provided that engages donor ribbon 30 and moves therewith. Follower wheel 77 can have surface features that are optically, magnetically or electronically sensed by movement sensor 75. One example of this is a follower wheel 77 that has markings thereon indicative of an extent of movement of donor ribbon 30 and a movement sensor 15 that has a light sensor that can sense light reflected by the markings. In other embodiments, perforations, cutouts or other routine and detectable indicia can be incorporated onto donor ribbon 30 in a manner that enables a movement sensor 75 to provide an indication of the extent of movement of the donor ribbon 30.

Alternatively, donor position sensor 70 can be adapted to sense the color of donor patches on donor ribbon 30 and can provide color signals to controller 20. In this alternative, controller 20 is programmed or otherwise adapted to detect a color that is known to be found in the first donor patch, e.g. yellow donor patch 34 in a set of donor patches. When the first color is detected, controller 20 can determine that donor ribbon 30 is positioned proximate to the start of a donor patch set.

Data including, but not limited to, control programs, digital images and metadata can also be stored in memory 68. Memory 68 can take many forms and can include, without limitation, conventional memory devices including solid state, magnetic, optical or other data storage devices. Memory 68 is shown having a removable memory interface 71 for communicating with removable memory (not shown) such as a magnetic, optical or magnetic disks. Memory 68 is also shown having an optional hard drive 72 that is fixed with printer 18.

Controller 20 has a communication system 74 for communicating external devices such as remote memory 76. Communication system 74 can be, for example, an optical, radio frequency circuit or transducer that converts electronic signals representing an image and other data into a form that can be conveyed to a separate device by way of an optical signal, radio frequency signal or other form of signal.

Controller 20 is operable to cause printing of differently sized images. In a full image mode, controller 20 prints images having image sizes that will exhaust most or all of the donor material in the donor patches of a donor patch set. In one example of this type, some images will be sized so that a single image will consume most or all of the donor material from an entire donor patch set. Likewise other combinations of images such as a request for a set of multiple wallet-sized prints will likewise consume substantially all of the donor material available in a single donor patch set. Controller 20 is also adapted to print images having various sizes that exhaust only a fraction of the donor material provided by a donor patch set and that leave a fractional donor set having donor patches with unused donor material that can be used to form what is referred to herein as a fractional size image.

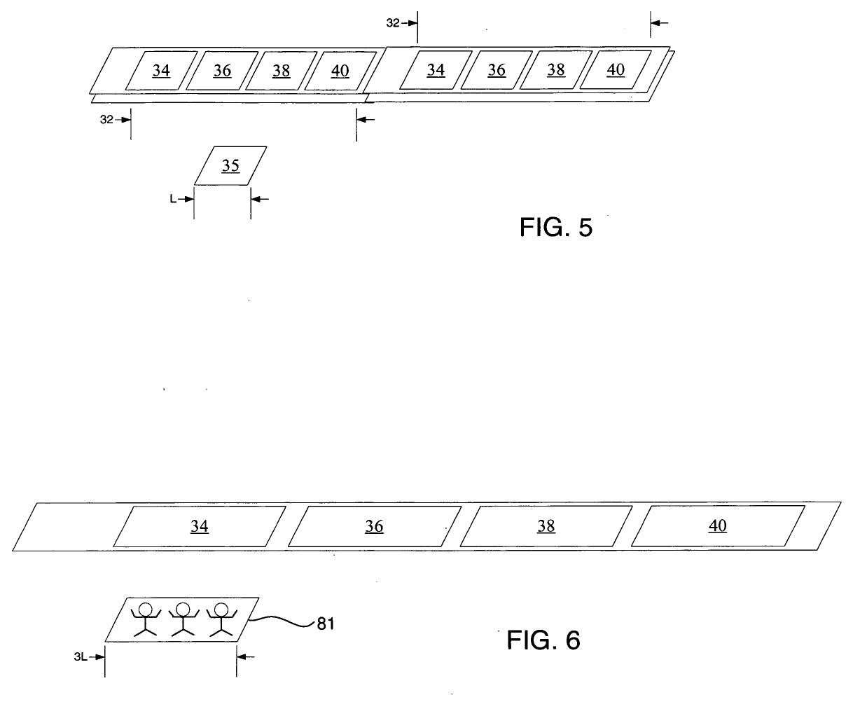

Conventionally, as illustrated in FIG. 5, each donor patch 34, 36, 38, and 40, of first donor patch set 32, is dimensioned to produce a standard sized print 35 where the length of an image in a print direction is denoted by the letter “L”. For example, a 4″×6″ print would have a length L equal to 4 inches. Typically, the size of each donor patch is slightly larger than the image being printed and typically print engines are not capable of printing wide-format images without printing multiple images together in very close proximity. Accordingly, it would not be possible to produce wide-format prints having a length of, for example and without limitation, greater than 2L, such as 3L or 4L on the system of FIG. 5.

The term wide-format image, as used herein, is typically used to refer to any image that is captured or cropped to an aspect ratio that is substantially longer along one axis, typically a horizontal axis, than along another orthogonal axis such as a vertical axis. A wide-format image can provide an image of a scene having a wide field of view across one axis of view as compared to a portion of that field that typically be observed in standard size prints, such as 2″×2″, 3.5″×5″, 4″×6″ prints. Such images often take the form of strips when printed and typically provide relatively consistent image detail across the long axis. A wide-format print can be, for example, greater than 2 times longer along one axis than along the other and can comprise, but is not limited to what is known in the art as a panoramic print.

Of course, one might merely lengthen donor patches 34, 36, 38, and 40 to accommodate the extended length of wide-format prints, as is shown in FIG. 6. While this would work well when a wide-format print 81 is being produced however, a very large amount of donor material would be wasted when printing standard size images as the conventional printer simply advances the donor ribbon 30 from first donor patch set 32 to a second donor patch before initiating a next job.

Accordingly, in printing system 16, controller 20 is adapted to cooperate with a printer driving device 80 to operate in a novel mode that allows controller 20 to execute a first print order using a portion of donor material from first donor patch set 32 and to further use remaining portions of the donor material from first donor patch set 32 to render at least two additional prints.

Referring back to FIG. 1, printer driving device 80 has an input 82 adapted to receive a print order requesting the printing of at least one image. Input 82 can comprise a manual user input for manually receiving a user input action and determining a print order at least in part based upon the user input action. Input 82 can also comprise a receiver for receiving a request from a remote source such as a telecommunication network, computer network or remote device such as a cellular telephone. For example, input 82 can include, but is not limited to, circuits and systems known to those of skill in the art for receiving entries made by way of user input action, or in response to a data provided by way of a memory (not shown) including, but not limited to, data provided by way of a removable memory (not shown).

When a print order is received from input 82, processor 84 analyzes the print order and forms a set of page data streams based upon the print order. Each page data stream comprises data representing one image from the print order in a format that can be used by printer 18 to cause one image from the print order to be printed. In this regard, processor 84 can be provided with printer driver software or custom application programming for use in forming the page data streams. Each page data stream is transmitted to printer 18. In the embodiment illustrated, the page data stream is transmitted by a signal sent by communication circuit 86 to communication system 74 of printer 18. A communication circuit 86 can also be used to receive print orders from remote sources and in that sense can also comprise input 82.

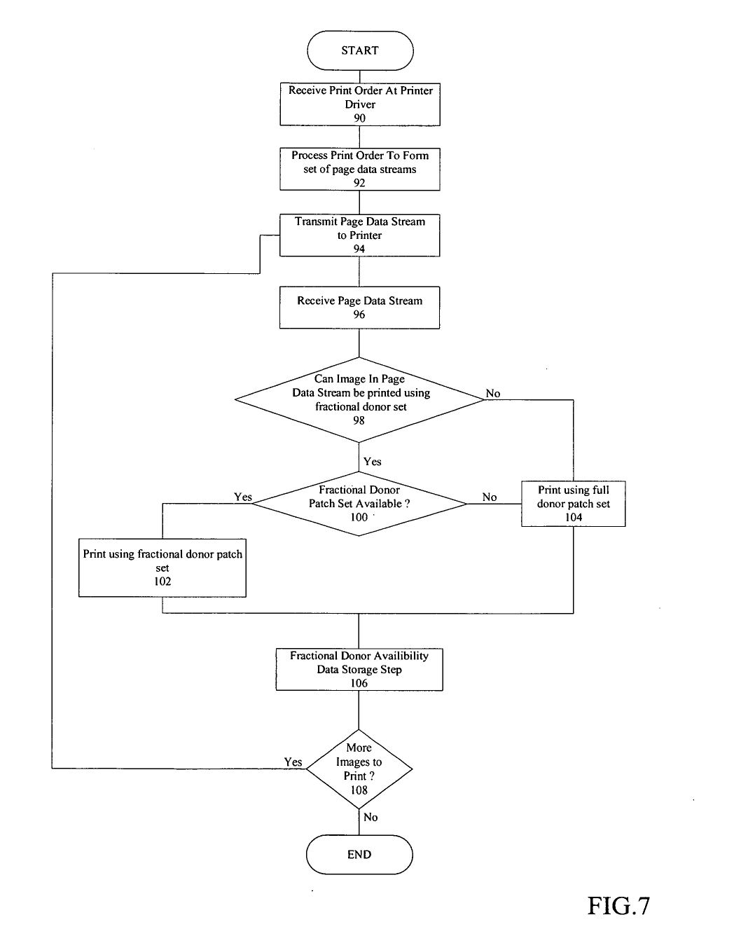

FIG. 7 provides a flow diagram showing one embodiment of a method for operating printer 18 in accordance with the invention. Printer driving device 80 receives a print order in any of the above-described manners (step 90) and processes the print order to form a set of page data streams. Each page data stream comprises image data representing one image from the print order in a format that can be used by printer 18 to print one image (step 92). For example, a page data stream can take the form of image data to be provided to printer 18 in a manner that can be used by printer 18 to print an image. In certain embodiments, the page data stream can also include metadata that provides information that describes the way in which an image is to be printed. Such metadata can optionally include metadata from which it can be determined whether the received page data stream can be printed using a fractional donor patch set. It will be appreciated that other information can be included in the metadata. Each page data stream is then transmitted by communication circuit 86 (step 94) and is received by communication system 74 of printer 18 (step 96).

Controller 20 receives each page data stream from communication system 74 and determines whether the image requested can be printed using a fractional donor patch set (step 98). One way to determine whether the image from a page data stream can be printed using a fractional donor patch is to analyze the image data and to make the determination based at least in part upon the amount of image information to be printed. This determination can also be made using other forms of image analysis. Where the page data stream includes metadata from which it can be determined whether the image can be printed using a fractional donor patch set, such metadata can be used to make this determination. Examples of such metadata include, but are not limited to, image size metadata, or image format metadata.

Controller 20 then determines whether a fractional donor patch set is available for printing (step 100). This can be done in a variety of ways. In one embodiment, controller 20 is adapted to store data that indicates whether such a fractional donor patch set is available. In one embodiment this is done by maintaining a log indicating all print orders executed using donor ribbon 30. In this embodiment, controller 20 is adapted to analyze the log data to determine whether such a fractional donor patch set is available. Alternatively, controller 20 can be adapted to make a determination after each print as to whether a fractional donor patch set is available on donor ribbon 30 and to record a fractional data flag that indicates the availability or non-availability of a fractional donor patch set on donor ribbon 30 (step 106).

In certain embodiments of the invention, the log or flag data can be stored in memory 68 of printer 18. However, in other embodiments, the log or flag data can be stored in a memory that is physically associated with the donor ribbon 30. For example, donor ribbon 30 can be physically associated with a memory button of the type sold by Dallas Semiconductor, Dallas, Tex., USA or some other type of memory that controller 20 can exchange data with by way of a physical connection. Donor ribbon 30 can also be physically associated with a memory that is capable of exchanging data wirelessly with controller 20 and/or communication system 74. For example, a radio frequency identification tag can be used to store data and to provide data to printer 18 by way of an exchange of wireless signals with communication system 74.

Optionally, controller 20 can also determine characteristics such as the type and size of donor ribbon 30 that remains in a donor patch set so that more refined determinations of the nature of the donor patch set that remains can be made. For the purposes of the discussion above, it has been assumed that controller 20 is adapted to cause images to be printed that are either wide-format images that use a large portion of the donor patch or standard format images that are printed in a fractional mode that uses only one portion of the donor material from each donor patch.

Where controller 20 determines that an image from a page data stream can be printed using a fractional donor patch and that a fractional donor patch is available, controller 20 will cause donor ribbon 30 to be positioned so that remaining portions of a fractional donor patch set are used in rendering the image (step 102).

Where controller 20 determines that the image from a page data stream cannot be printed using a fractional donor patch set, or where controller 20 determines that a fractional donor patch set is not available, controller 20 can cause a subsequent full donor patch set i.e., second set of donor patches to be used for printing the image (step 104).

Controller 20 can optionally record the location of a fractional donor patch e.g. first donor patch set 32 so that it can be used in a subsequent print order (step 90), or alternatively, controller 20 can ignore that fractional donor patch set but improve donor use efficiency by using donor material from other fractional donor patch sets (not shown) that arise during later printing operations. This latter embodiment allows inconveniently located fractional donor patch sets to be ignored so as to provide increased printer speed. This process is repeated for each image requested in the print order (step 108).

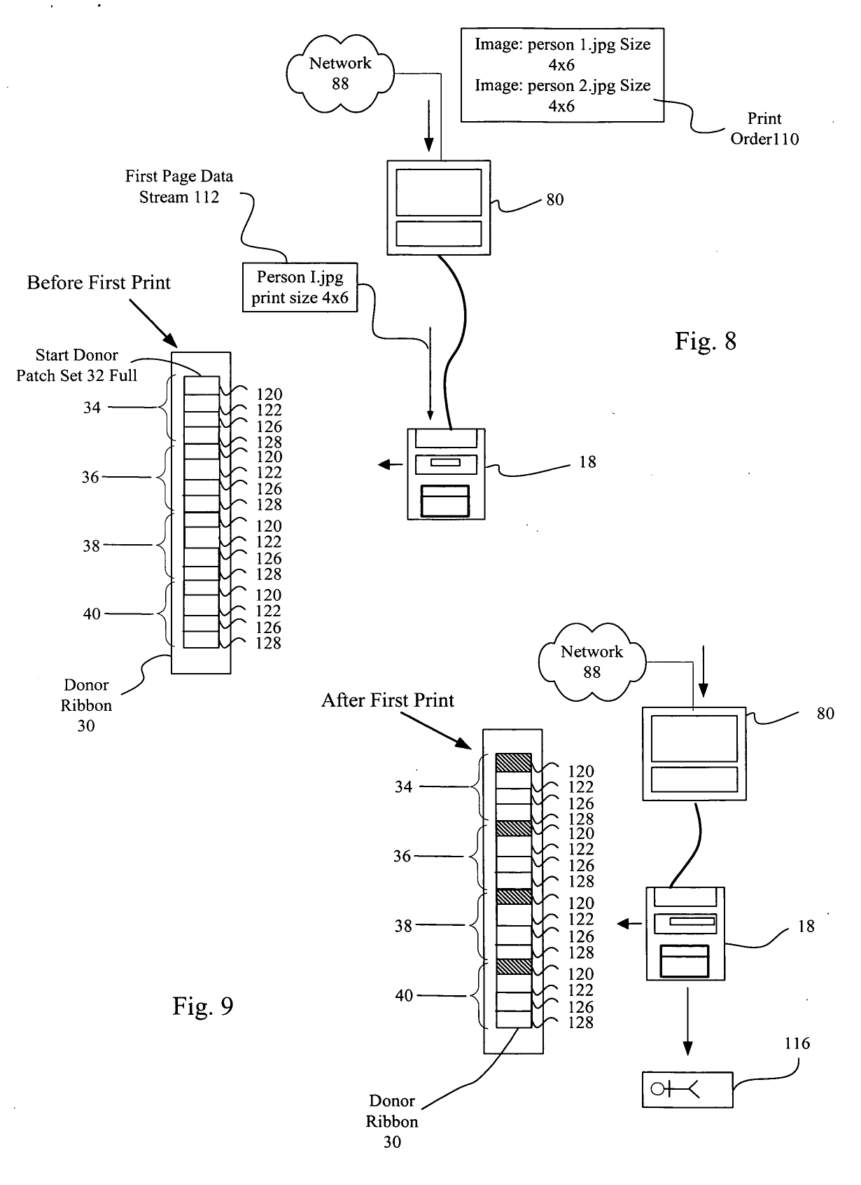

FIGS. 8-12 illustrate a print order 110 requesting the printing of four standard format images, each image requiring the use of a fractional set of donor patches. In this example, a print order 110 is received from a network 88 by input 82 of printer driving device 80 and provided to a processor 84 (step 90). Processor 84 processes print order 110 by converting the print order 110 into a set of four page data streams with a first page data stream 112 being used to define one of the images to be printed in the print order and a second page data stream 114 being used to define a second image in the print order (step 92). First page data stream 112 is then transmitted by communication circuit 86 of printer driving device 80 to printer 18 (step 94).

Communication system 74 of printer 18 receives the transmitted page data stream (step 96) and provides this to controller 20. Controller 20 then analyzes first page data stream 112 to determine whether the image in first page data stream 112 can be printed using a fractional donor patch set (step 98). In this example illustration, first page data stream 112 contains metadata, in this case print size metadata indicating that a 4″×6″ print is to be rendered. Accordingly, controller 20 reads this print size metadata and determines from this that a printed first image 116 will consume only a fraction of the donor material available in first donor patch set 32.

As illustrated in FIG. 8, when printer 18 is at an initial start-up point, donor ribbon 30 has a first donor patch set 32 available for full size printing and that has sufficient donor material in donor patches 34, 36, 38 and 40 within donor patch set 32 to allow up to four standard size images to be printed using portions 120, 122, 126 and 128. In this example, such standard sized images are considered to be 4″×6″ images. Accordingly, in this example, the overall length of each of donor patches 34, 36, 38 and 40 is 16 inches while the overall width is 6 inches. Controller 20 then causes a 4″×6″ image to be printed using fractions 120 of the of 6″×16″ donor patches 34, 36, 38 and 40 of first donor patch set 32. As is shown in FIG. 9, at the completion of printing first image 116 based upon first page data stream 112, first donor patch set 32 has donor patches 34, 36, 38 or 40 with three fractional-size fraction patches 122, 126 and 128 available for printing with fraction patch 120 having been used for printing. Controller 20 stores a flag in memory 68 indicating that first donor patch set 32 is available for printing a fractional size image.

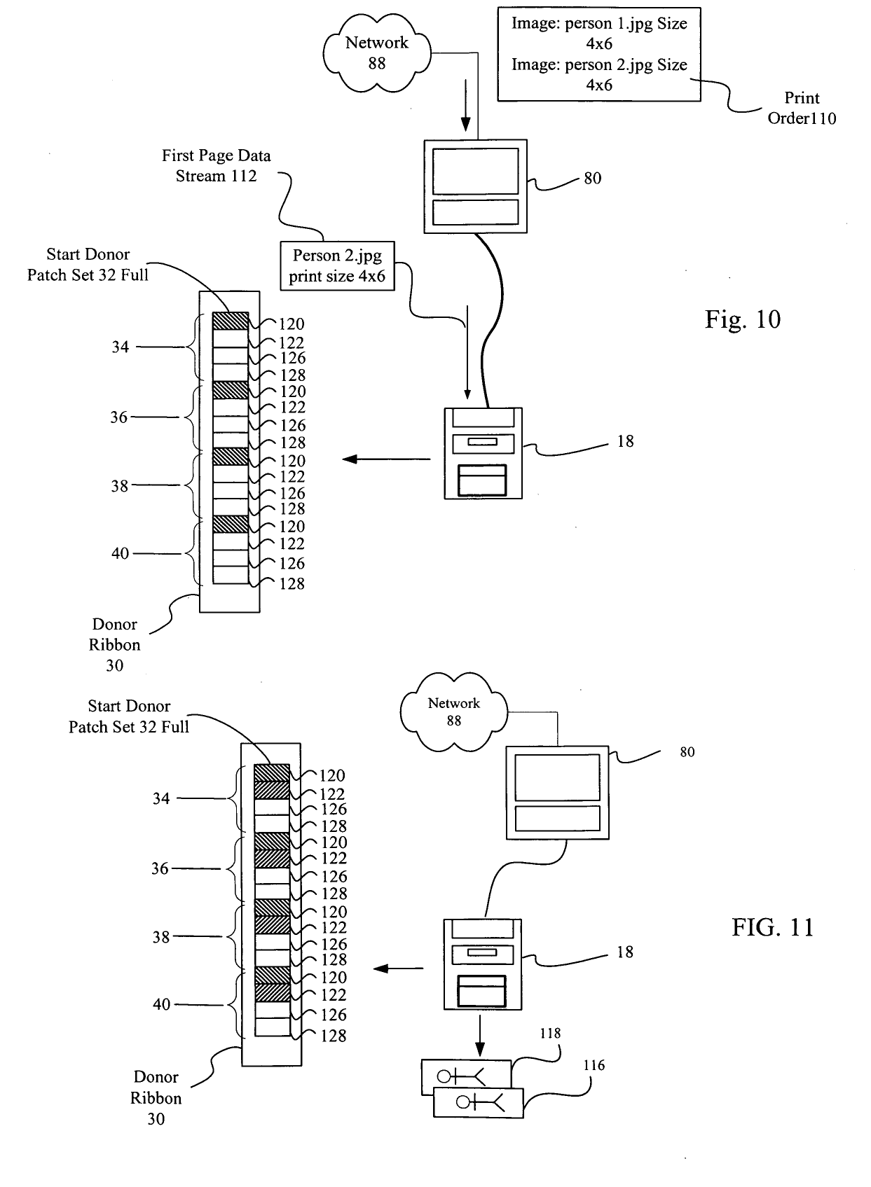

Printer driving device 80 then causes communication circuit 86 to transmit a second page data stream 114 (steps 94 and 108). As shown in FIG. 10, communication system 74 receives second page data stream 114 and provides this to controller 20. Controller 20 determines whether the image to be printed in accordance with second page data stream 114 can be printed using a fractional donor patch set. Here, because second page data stream 114 contains metadata indicating that a 4″×6″ image is to be printed, controller 20 determines that the image of the second page data stream 114 can be printed using the donor material from fraction patch 122 and/or fraction patches 126 and 128.

Controller 20 then determines whether a fractional donor patch set is available for printing (step 100). Controller 20 does this by accessing the flag data stored in memory 68, which indicates that first donor patch set 32 is now a fractional donor patch set that is available for printing. Accordingly, as shown in FIG. 11, controller 20 causes a second 4″×6″ image 118 to be printed based upon the image contained in second page data stream 114 using the another fraction of donor material from first donor patch set 32. As is shown in FIG. 11, at the completion of printing second image 118 based upon second page data stream 114, first donor patch set 32 has donor patches 34, 36, 38 and 40 with two fraction patches 126 and 128 available for printing with fraction patches 120 and 122 having been used for printing. Again, controller 20 stores a flag in memory 68 indicating that first donor patch set 32 is available for printing a fractional size image. This flag can indicate, for example, that donor patch set 32 has fraction patches 126 and 128 available for printing.

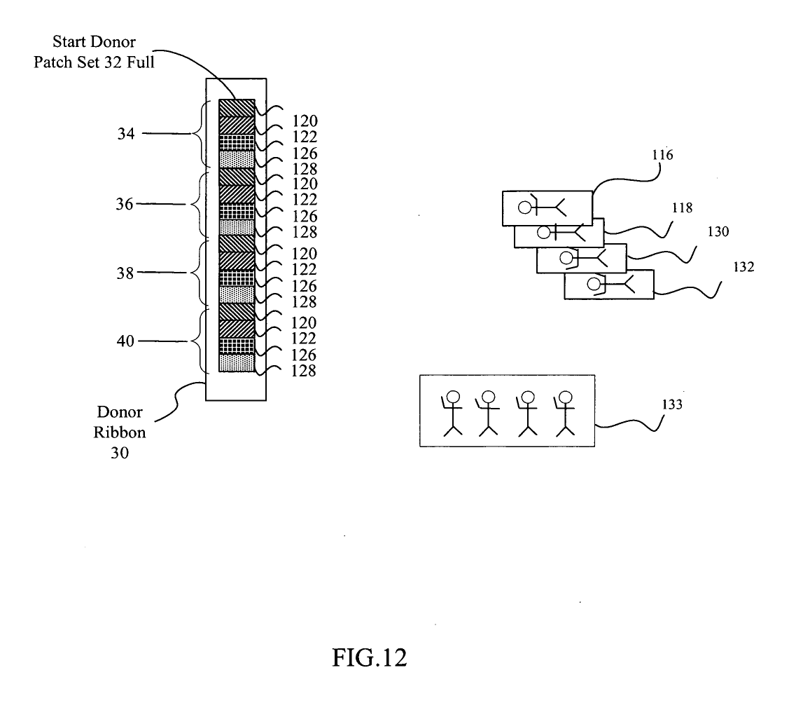

The process is repeated for subsequent data streams until first donor patch set 32 is exhausted. FIG. 12 shows four fractional sized images 116, 118, 130 and 132 have been produced from first donor patch set 32 of donor patches 34, 36, 38 and 40.

It will be appreciated that, in order to use fraction patches of donor material from first donor patch set 32 in printing a second image 118, or other images, controller 20 must be capable of properly positioning first donor patch set 32 so that printhead 22 confronts only remaining fraction patches 120 of donor patches 34, 36, 38 and 40 while printing second image 118. After first print 116, controller 20 can optionally cause donor ribbon supply roller 50 and donor ribbon take-up roller 48 to operate to move donor ribbon 30 from a position with donor ribbon 30 at the completion of the first print, to a position that aligns a remaining fraction patch, such as fraction patch 122 of yellow donor patch 34 with printhead 22 for subsequent printing, so that printing of a fractional size print in response to second page data stream 114 can be initiated immediately. Controller 20 can controllably position donor ribbon 30 so that fraction patches of first donor patch set 32 can be used in printing a second print by causing donor ribbon take-up roller 48 and donor ribbon supply roller 50 to reverse the direction of donor ribbon movement after completing the first printing job and by using donor position sensor 70 to detect the start of first donor patch set 32 in the same manner as position sensor 70 can detect the start of first donor patch set 32 when donor ribbon 30 is advanced in a forward direction.

Once a donor ribbon 30 is positioned with printhead 22 at a leading edge LE of first donor patch set 32, controller 20 can determine a usable patch offset distance from the leading edge LE of each patch and can use the offset distance to adjust the pattern of donor ribbon 30 movement so that only fraction patches 120 of each donor patch are used for printing. Controller 20 can determine the useable patch offset distance based upon the size of first image 116 and the overall size of the donor patches. For example, where donor patches 34, 36, 38 and 40 of first donor patch set 32, shown in FIGS. 8-12, are each 6″×16″ patches and where first image 116 was of 4″×6″ size, it can be determined that the first print order consumed the first four inches of each donor patch.

Accordingly, controller 20 determines a patch offset distance of four inches. As is illustrated in FIG. 9, when a subsequent print order is received that requires the printing of a 4″×6″ image, controller 20 causes donor ribbon 30 to be moved forward four inches from the start the yellow donor patch 34 in first donor patch set 32, and requires that printing begin at that point and continue only for another four inches. Controller 20 then moves donor ribbon 30 a distance that is equivalent to a full donor patch plus any inter-patch spacing so that printing of the second donor patch begins four inches from the start of the next donor patch, magenta donor patch 36. This process repeats for each donor patch, exhausting all of the fraction patches 120 of donor patches 34, 36, 38, and 40 of first donor patch set 32.

In this way all fraction patches of first donor patch set 32 that were not used in rendering a first print order can be used to render at least a part of a second print order.

It will be appreciated that using this approach, a printer driving device 80 is provided that is adapted to organize and direct page data streams to controller 20 in a manner that allows controller 20 to determine whether to print an image using a fractional donor patch set without requiring that the controller 20 be necessarily adapted to receive print orders or to process print orders for printing.

In the embodiment that is illustrated, printer 18 is shown having a printer-driving device 80 that is separate from printer 18. It will be understood that in other embodiments, printer-driving device 80 can be combined in whole or in part with printer 18. For example, in one embodiment of this type, controller 20 can act both as described above and can also perform the functions of processor 84.

It will also be appreciated that the example has assumed, for simplicity, that printer 18 is used to print two sizes of image. However, as noted above, there need not be a single standard format image size, but instead a standard format image may be any of a wide range of standard format image sizes including, but not limited to, 2″×2″, 2″×3″, 3.5″×5″, 4″×6″, 5″×7″, 8″×10″, 8.5″×11″, A4, or any other known format image sizes. Thus, printer 18 can be used to print any of a number of different image sizes from a full patch length to a fractional patch length.

The invention has been described in detail with particular reference to certain preferred embodiments thereof, but it will be understood that variations and modifications can be effected within the spirit and scope of the invention.

### PARTS LIST

16 printing system
18 printer
20 controller
22 printhead
26 receiver medium
30 donor ribbon
32 first donor patch set
34 yellow donor patch
35 standard-sized print
36 magenta donor patch
38 cyan donor patch
40 clear overcoat patch
42 receiver medium take-up roller
44 receiver medium supply roller
46 platen roller
48 donor ribbon take-up roller
50 donor ribbon supply roller
52 image receiving area
54 stripping plate
56 idler roller
62 user input system
64 output system
66 sensors
68 memory
70 donor position sensor
71 removable memory interface
72 hard drive
74 communication system
75 movement sensor
76 remote memory
77 follower wheel
79 receiver medium position sensor
80 printer driving device
81 wide-format print
82 input
84 processor
86 communication circuit
88 network
90 receive print order step
92 process print order to form set of page data streams step
94 transmit page data stream step
96 receiver page data stream step
98 image printed using fractional donor set determining step
100 fractional donor patch set available step
102 print using fractional donor patch set step
104 print using full donor patch set step
106 data flag/log step
108 more images for printing determining step
110 fractional donor patch set available step
112 page data stream
114 page data stream
116 first image
118 second image
120 fraction patch
122 fraction patch
126 fraction patch
128 fraction patch
130 image
132 image
133 wide-format image
LE leading edge of donor patch set
TE trailing edge of donor patch set
LED leading edge of donor patch
TER trailing edge of image receiving area
LER leading edge of image receiving area

1. A method for selectively printing standard format images having a length L in a print direction and wide-format images having a length greater than 2L in the print direction, said method comprising the steps of:
receiving at least one print order at a thermal printer requesting the printing of an image of one of said standard format and said wide-format; and
advancing a donor ribbon through the thermal printer in the print direction, said donor ribbon having patches of donor material of length in the print direction greater than 2L;
printing an image based upon each print order, wherein said printing is performed using donor material on:
(1) a fraction of a donor patch when the print order requests a standard format image, and
(2) up to a full donor patch when the print order requests a wide-format image.

2. A method as set forth in claim 1, wherein the length of said wide-format images is nL, where n is greater than 2.

3. A method as set forth in claim 1, wherein the length of said wide-format images is 4L.

4. A thermal printing system for printing of at least one image of a print order, said thermal printing system comprising:
a processor adapted to form a set of page data streams based upon a received print order, each page data stream comprising data representing one image;
a printer adapted to print images for each of the page data streams by transferring donor material from patches on a donor ribbon to receiver media, said printer being operable to print images in a manner that exhausts either:
a fractional set of donor patches when it is determined that the image from the received page data stream can be printed using a fractional set of donor patches, or up to
a full donor set of patches, said full donor set of patches being greater than two times the length of said fractional set of donor patches,

5. The thermal printing system of claim 4, wherein said printhead is further adapted to print an image using donor material from the fractional set of donor patches by determining a position of a starting edge for each unused portion of each donor patch in the fractional set of donor patches based upon a detected start of the fractional set of donor patches.

6. The thermal printing system of claim 5, further comprising the step of determining an offset distance indicating a distance from the leading edge of each patch to which donor ribbon is to be advanced before printing an image using the available fractional donor patch.

7. The thermal printing system of claim 4, wherein the processor is within the printer.
